(19) United States
(12) Patent Application Publication
(10) Pub. No.: US 2023/0072125 A1
(43) Pub. Date: Mar. 9, 2023

(54) DATA READING METHOD, APPARATUS, AND NON-TRANSITORY COMPUTER READABLE MEDIUM

(71) Applicant: Alibaba Cloud Computing Co. Ltd., Hangzhou (CN)

(72) Inventors: Yu FU, Hangzhou (CN); Jianghang LOU, Hangzhou (CN); Wei CAO, Hangzhou (CN); Feifei LI, Hangzhou (CN)

(21) Appl. No.: 18/056,460

(22) Filed: Nov. 17, 2022

Related U.S. Application Data
(63) Continuation of application No. PCT/CN2021/100495, filed on Jun. 17, 2021.

(30) Foreign Application Priority Data
Jun. 19, 2020 (CN) 202010568737.9

(51) Int. Cl. G06F 11/14; G06F 16/27; G06F 16/23

(52) U.S. Cl. CPC G06F 11/1448; G06F 16/27; G06F 16/2322; G06F 2201/84

(57) ABSTRACT

A data reading method and apparatus are provided. The data reading method includes: receiving a data reading transaction request; acquiring a snapshot timestamp based on the data reading transaction request; and sending, when the snapshot timestamp is less than a maximum commit timestamp for a write transaction of a first database, the data reading transaction request carrying the snapshot timestamp to the first database for data reading.

### CROSS-REFERENCE TO RELATED APPLICATIONS

The disclosure claims the benefits of priority to PCT Application No. PCT/CN2021/100495, filed Jun. 17, 2021, which claims the benefits of priority to Chinese Application No. 202010568737.9, filed Jun. 19, 2020, both of which are incorporated herein by reference in their entireties.

### TECHNICAL FIELD

The present disclosure generally relates to a field of data processing technologies, and more particularly, to data reading methods, apparatus, and non-transitory computer readable medium.

### BACKGROUND

At present, most of the distributed databases on the market do not support consistent read of a standby database, and the so-called consistent read of the standby database means that results read from the standby database and the primary database at the same time are consistent. Generally, due to the delay in replication between the primary database and standby database, the data status on the standby database lags behind that of the primary database, which may lead to different results read from primary database and standby database. That is, the data in the standby database is asynchronous with that in the primary database, causing the data read from the standby database to be inconsistent with the data in the primary database.

Therefore, it is necessary to provide a data reading method that can achieve the same reading results from the primary database and the standby database, to ensure consistent read of primary database and standby databases.

### SUMMARY OF THE DISCLOSURE

Embodiments of the present disclosure provide a data reading method. The method includes receiving a data reading transaction request; acquiring a snapshot timestamp based on the data reading transaction request; and sending, when the snapshot timestamp is less than a maximum commit timestamp for a write transaction of a first database, the data reading transaction request carrying the snapshot timestamp to the first database for data reading.

Embodiments of the present disclosure provide an apparatus for performing data reading. The apparatus includes a memory configured to store instructions; and one or more processor configured to execute the instructions to cause the apparatus to perform: receiving a data reading transaction request; acquiring a snapshot timestamp based on the data reading transaction request; and sending, when the snapshot timestamp is less than a maximum commit timestamp for a write transaction of a first database, the data reading transaction request carrying the snapshot timestamp to the first database for data reading.

Embodiments of the present disclosure provide a non-transitory computer readable medium that stores a set of instructions that is executable by one or more processors of an apparatus to cause the apparatus to initiate a method for performing data reading. The method includes receiving a data reading transaction request; acquiring a snapshot timestamp based on the data reading transaction request; and sending, when the snapshot timestamp is less than a maximum commit timestamp for a write transaction of a first database, the data reading transaction request carrying the snapshot timestamp to the first database for data reading.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram of a data reading apparatus, according to some embodiments of the present disclosure.

FIG. 2 is a flowchart of a data reading method, according to some embodiments of the present disclosure.

FIG. 3 is a flowchart of a processing process of a first data reading method, according to some embodiments of the present disclosure.

FIG. 4 is a flowchart of a processing process of a second data reading method, according to some embodiments of the present disclosure.

FIG. 5 is a schematic structural diagram of a data reading apparatus, according to some embodiments of the present disclosure.

FIG. 6 is a structural block diagram of a computing device, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

In the present disclosure, a data reading method is provided. One or more embodiments of the present disclosure also relate to a data reading apparatus, a computing device, and a computer-readable storage medium, which are described in detail one by one in the following embodiments.

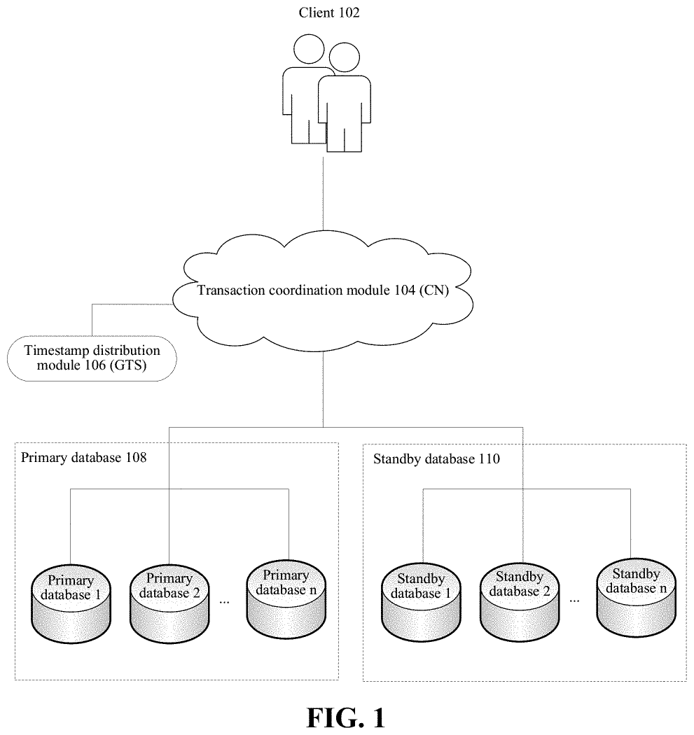

FIG. 1 is a schematic diagram of an example data reading apparatus, according to some embodiments of the present disclosure. The data reading apparatus includes a client 102, a transaction coordination module 104 (for example, a coordinator node (CN)), a timestamp distribution module 106 (for example, Global Timestamp Service (GTS)), primary database(s) 108, and standby database(s) 110. A timestamp is usually a 64-bit integer, and is used for comparing and determining a temporal relationship between events. A CN is responsible for coordinating and executing transactions on one or more data nodes (DNs), and an entire database is usually distributed on a plurality of DNs in the form of sharding. A GTS is responsible for issuing timestamps. All other nodes in the data reading apparatus in the embodiments of the present disclosure request timestamps from the GTS.

During specific implementation, the CN receives a read transaction request, for example, a transaction request for querying for some data, sent by the client 102. The read transaction request in this example is consistent with the content to be expressed in the data reading transaction request in the following embodiments. The read transaction includes one or more SQL statements, and the specific data to be read or queried for under the read transaction request can be specified through the SQL statement. A transaction is an execution unit including a plurality of SQL statements, and having four characteristics of atomicity, consistency, isolation, and durability.

The CN 104 simultaneously sends a request for acquiring the corresponding snapshot timestamp for the read transaction request to the GTS 106. After receiving a snapshot timestamp of the read transaction returned by the GTS 106, the CN 104 sends the read transaction request carrying the snapshot timestamp to each standby database 110 corresponding to the read transaction request, and acquires the maximum commit timestamps for a write transaction of all the standby databases 110, where the commit timestamp is the maximum commit timestamp for the primary databases 108 to execute the write transaction to the corresponding standby databases 110, and the commit timestamp is incremented according to write transactions executed by the primary databases 108. Specifically, when the primary database 108 executes a write transaction to the standby databases 110, scheduling is also performed through the CN 104. Each time a write transaction is executed, the CN 104 also sends a request for acquiring a timestamp to the GTS 106, acquires the corresponding commit timestamp for the write transaction, and the like. A snapshot timestamp is also referred to as snapshot_seq, which is a snapshot timestamp of a transaction, where visibility of a data version is determined according to the timestamp, and a commit timestamp is also referred to as commit_seq, which is a commit timestamp of a transaction.

When the corresponding snapshot timestamp acquired based on the read transaction request is determined to be less than the maximum commit timestamp for the write transaction of all the standby databases 110, that is, the snapshot timestamp is earlier than the latest commit timestamp, it can be determined that the data of the read transaction request in the primary databases 108 has already been all written to the standby databases 110 before the snapshot timestamp. Then, the data read from the primary databases 108 and the standby databases 110 based on the read transaction request of the snapshot timestamp can be kept consistent. It is unnecessary to introduce other additional network requests or optimize network resources. In addition, by acquiring a snapshot timestamp of a read transaction once only, the data acquired from the standby databases 110 based on the read transaction request of the snapshot timestamp and the data acquired from the primary databases 108 based on the read transaction request of the snapshot timestamp can be kept consistent, thereby improving the user experience.

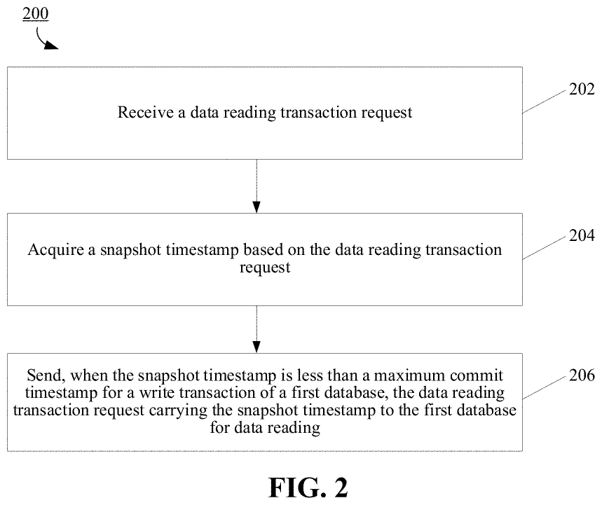

FIG. 2 is a flowchart of an example data reading method 200, according to some embodiments of the present disclosure. The method includes the following steps 202 to 206.

At step 202, a data reading transaction request is received.

Specifically, the data reading method 200 provided in this example of the present disclosure is applied to a distributed database, and is specifically applied to a Multi-Version Concurrency Control (MVCC) mechanism. MVCC is a common concurrency control mechanism for databases, where each piece of data is stored with a plurality of versions, and for a read request of a transaction, a version visible to the read request is always read, which does not block a write request. A specific execution object of the data reading method is the CN in the foregoing embodiments.

The data reading transaction request may be understood as a request for a data reading transaction to be executed, and the data reading transaction includes one, two, or more SQL statements, such as SELECTMAX(sal), MIN(age), AVG(sal), and SUM(sal) FROM emp. In practical applications, the data reading transaction request is generally sent by a client.

At step 204, a snapshot timestamp is acquired based on the data reading transaction request.

Specifically, after receiving the data reading transaction request sent by the client, the CN sends, based on the data reading transaction request, a request for acquiring a snapshot timestamp for the data reading transaction to the GTS. The GTS generates a snapshot timestamp for the data reading transaction, and returns the snapshot timestamp to the CN. For ease of understanding, the data reading method is described in detail below by using an example in which the snapshot timestamp is a snapshot_seq.

During specific implementation, when receiving the snapshot timestamp of the data reading transaction returned by the GTS, the CN acquires the maximum commit timestamp for a write transaction of a first database. In practical applications, the first database may be understood as a standby database, that is, a backup database of the primary database; and the maximum commit timestamp for the write transaction of the first database may be understood as the maximum commit timestamp for the write transaction for writing data to the standby database by the primary database.

In practical applications, data reading and data writing do not affect each other. Data writing is not affected when data reading is performed. For example, during execution of data querying, the data in the primary database is backed up to the standby database synchronously, and the data backup is not terminated due to the execution of the data querying transaction. Each time the data in the primary database is written to the standby database, it is equivalent to executing a write transaction once. When the CN schedules the data in the primary database and writes the data to the standby database, a commit timestamp for the write transaction is generated in the GTS.

In addition, because the data reading method is applied to a distributed database, there are a plurality of sharding primary databases and a plurality of corresponding sharding standby databases. When the CN backs up the data of the primary database to the standby database, it backs up the data in the plurality of sharding primary databases to the plurality of corresponding sharding standby databases. In this case, according to the different amount of data to be backed up, the time to complete the write transaction are also different. Therefore, a plurality of commit timestamps are generated, and in this example, the acquired maximum commit timestamp for the write transaction of the first database is the maximum commit timestamp for the write transaction of all the standby databases.

At step 206, when the snapshot timestamp is less than a maximum commit timestamp for a write transaction of a first database, the data reading transaction request carrying the snapshot timestamp is sent to the first database for data reading.

When the snapshot timestamp is less than the maximum commit timestamp for the write transaction of the standby databases, the data reading transaction request carrying the snapshot timestamp is sent to the first database for data reading, and data read by the first database based on the data reading transaction request carrying the snapshot timestamp is received.

Specifically, the snapshot timestamp being less than a maximum commit timestamp for a write transaction of the first database includes: the snapshot timestamp being less than a maximum commit timestamp for a write transaction of a second database to the first database, where the first database is a backup database of the second database.

The second database may be understood as the primary database in the foregoing embodiments.

In this example, according to the data reading method, the snapshot timestamp is compared with the maximum commit timestamp for the write transaction of the standby databases, and consistency between data acquired from the primary database and the standby databases under the same data reading transaction request can be realized based on the snapshot timestamp, which improves the user experience.

For example, if the snapshot timestamp of the data reading transaction request sent by the client is ****12:05:02, and the maximum commit timestamp for the write transaction of the first database is ****12:05:03 (i.e., the latest commit timestamp), it can be determined that when the data reading transaction request from the client is received, all the data in the primary database before ****12:05:02 have been backed up to the standby databases. In this case, data with a timestamp before ****12:05:02 acquired from the standby database and data with a timestamp before ****12:05:02 acquired from the primary database according to the data reading transaction request are kept consistent. That is, if the completion time of writing data to the standby database by the primary database is earlier than the time for executing the data reading transaction request by the standby database, data read from the primary database and the standby database under the data reading transaction request can be consistent.

In the data reading method, acquisition for a snapshot timestamp is performed once, and consistency between data of distributed standby databases and data of the corresponding primary database read under the same data reading transaction request can be ensured based on the snapshot timestamp, which improves the user experience for data reading and querying in the distributed standby databases.

In some embodiments, after the acquiring a snapshot timestamp based on the data reading transaction request, the method further includes: reacquiring, when the snapshot timestamp is greater than the maximum commit timestamp for the write transaction of the first database, a maximum commit timestamp for the write transaction of the first database, after waiting for a preset duration.

The preset duration may be set according to actual applications, and is not limited herein. For example, the preset duration is set to 1 ms or 2 ms, and the like.

Specifically, to avoid poor experience caused to a user by directly terminating the data reading transaction request when the snapshot timestamp is greater than the maximum commit timestamp for the write transaction of the first database, a waiting time acceptable to a distribution database of the database is set when the snapshot timestamp is greater than the commit timestamp. After a preset duration is waited for, a maximum commit timestamp for the write transaction of the first database is reacquired for determining. The consistency between the read data of the primary database and the standby databases is ensured through determining based on snapshot timestamps twice without affecting the processing of the data reading transaction request. When the data of the primary database and the standby database are determined to be inconsistent based on the snapshot timestamp for the first time, a second opportunity for determining is strived for the data reading transaction request of the client, and directly ending of the data reading transaction request of the client is avoided, so that the user needs to submit the data reading transaction request again for a plurality of times in this case, to increase the user's data reading time.

During specific implementation, after the maximum commit timestamp for the write transaction of the first database is reacquired after the preset duration is waited for, and whether the snapshot timestamp is smaller than the maximum commit timestamp for the write transaction of the first database is determined again. If the snapshot timestamp is smaller than the maximum commit timestamp, the above process continues to be performed, and if the snapshot timestamp is not smaller than the maximum commit timestamp, to ensure the normal progress of the data reading transaction request, data acquired from the standby databases by the client under the same data reading transaction request and data acquired from the primary database under the data reading transaction request are ensure to be consistent in a log sequence number (LSN) manner. More details about the specific implementation are described hereinafter.

After the reacquiring a maximum commit timestamp for the write transaction of the first database after waiting for a preset duration, the method further includes: acquiring an LSN of a second database when the snapshot timestamp is less than the maximum commit timestamp for the write transaction of the first database; sending the data reading transaction request carrying the LSN of the second database to the first database, and acquiring an LSN of the first database; and reading data in the first database based on the data reading transaction request and the LSN of the first database when the LSN of the first database is determined to match the LSN of the second database.

The LSN is the unique number of each record in a transaction log. Every time write transaction commit is performed by the data in the primary database, a record is generated in the log. A corresponding LSN is generated for each record, and the LSN is simultaneously stored in the file and the corresponding data table.

Specifically, when a data reading transaction request is received, and the snapshot timestamp of the data reading transaction request is determined to be greater than the maximum commit timestamp for the write transaction of the standby databases, an LSN of the primary database is acquired, and then the data reading transaction request carrying the LSN of the primary database is sent to the standby databases corresponding to the primary database respectively. Subsequently, an LSN of the standby database is obtained, and when the LSN of the primary database matches the LSN of the standby database, data is read from the first database based on the data reading transaction request and the LSN of the first database.

In practical applications, the data in the primary database is backed up to the standby database synchronously, so that LSNs of the data are also be backed up to the standby database synchronously. If there is an LSN in the standby database being the same as an LSN in the primary database, it means that the data corresponding to the LSN in the primary database has been all backed up to the standby database, and the data of the primary database and the standby database are consistent. In this case, data which is consistent with the data in the primary database can be read from the standby database based on the data reading transaction request and the LSN of the standby database. For example, in this case, there is data with LSNs 1-300 in the primary database, and there is also data with LSNs 1-300 in the standby database, then the data read from the primary database and the standby database under the data reading transaction request is consistent.

During specific implementation, the acquiring an LSN of a second database includes: acquiring an LSN of the last complete database backup of the second database. The acquiring an LSN of the first database correspondingly includes: acquiring an LSN of the last complete database backup of the first database.

Specifically, acquisition of the LSN of the last complete database backup of the second database and acquisition of the LSN of the last complete database backup of the first database are both for ensuring that the data in the standby database is the data of the last backup of the primary database, to ensure the real-time performance of the data.

However, because the data reading method in this example is applied to a distributed database, one data reading transaction request may correspond to a plurality of primary databases and a plurality of standby databases. Therefore, after a data reading transaction request sent by the client is received, the data reading transaction request is parsed first, and the corresponding primary database is determined for subsequent data processing in the corresponding primary database. More details about the specific implementation are described hereinafter.

After the receiving a data reading transaction request, the method further includes: determining at least one corresponding second database based on the data reading transaction request.

During specific implementation, the acquiring an LSN of a second database includes: acquiring an LSN of each second database. The sending the data reading transaction request carrying the LSN of the second database to the first database correspondingly includes: sending the data reading transaction request carrying the LSN of the second database to the first database corresponding to each second database.

Specifically, after at least one corresponding primary database is determined based on the data reading transaction request, an LSN of each primary database is acquired, and then the LSN of each primary database is bound to the data reading transaction request respectively. Subsequently, the data reading transaction request bound to the LSN of each primary database is sent to the standby database corresponding to each primary database, so that the standby database can process the data reading transaction request based on the LSN, to ensure that the data read from the standby database under the data reading transaction request and the data in the primary database are consistent, thereby avoiding data omission.

In practical applications, to ensure the running speed of the database, data reading is often performed in the standby database, and data writing is performed in the primary database. After a data reading transaction request from the client is received, data reading is performed in the standby database. In this case, it is necessary to ensure that the data read from the primary database the data read from the standby database under the data reading transaction request are consistent, and only in this case, the data read from the standby database under the data reading transaction request can be used normally. Therefore, data read from the standby database under the same data reading transaction request and data read from the primary database under the data reading transaction request are ensured to be consistent through determining on the snapshot timestamp or in an LSN manner, thereby enhancing the user experience.

The data reading method provided in the present disclosure is cleverly designed and utilizes the monotonicity of the GTS timestamp to establish a causal relationship on the global shards, and by acquiring a timestamp once only, the primary and standby consistency determining on all shards can be satisfied, which reflects good network optimization and saves network resources.

When using the data reading method, for the case that the snapshot timestamp of the data reading transaction is greater than the maximum commit timestamp for the write transaction of the first database, the foregoing steps are retried after a preset duration is waited for and the data reading can be satisfied, and a correctness verification can be performed as follows.

It is assumed that a write transaction T1 (that is, a transaction that has been written to the primary database before) is synchronized to the standby database through a synchronization link. In some embodiments, the write transaction T1 may be regarded as data to be read, and there is a read transaction S. In practical applications, T1 shall be visible to S. That is, in the standby database, either T1 is visible to S, or S is blocked and waits for T1 being visible to S which is determined according to a timestamp.

If T1.commit_seq <S.snapshot_seq, S.snapshot_seq<max_commit_seq, that is, there is a commit event T2.commit, and T2.commit_seq >S.snapshot_seq. Specifically, commit timestamp of T1 is less than the snapshot timestamp of S, the snapshot timestamp of S is less than the maximum commit timestamp for the write transaction of the standby databases, and the max_commit_seq is obtained by the write transaction T2.

It can be learned from T1.commit_seq <S.snapshot_seq that, T1.commit_seq < T2.commit_seq, so that T1.GetCommitTS --> T2.GetCommitTS (where --> means happens-before). Specifically, because the commit timestamp of T1 is smaller than the snapshot timestamp of S, and the snapshot timestamp of S is smaller than the commit timestamp of T2, it can be considered that the commit timestamp of T1 is smaller than the commit timestamp of T2, that is, the commit timestamp acquired from T1 is before the commit timestamp acquired for T2.

The transaction commit process includes Prepare -> GetCommitTS -> Commit, so there are:

T1.Prepare --> T1.GetCommitTS --> T1.Commit

T2.Prepare --> T2.GetCommitTS --> T2.Commit.

Specifically, the transaction commit process includes: preparing, acquiring a commit timestamp, and committing, so this transaction commit process is as follows:

Preparing T1, acquiring the commit timestamp of T1, and committing T1;

Preparing T2, acquiring the commit timestamp of T2, and committing T2.

According to the above, it can be learned that preparing T1 and acquiring the commit timestamp of T1 are before preparing T2 and acquiring the commit timestamp of T2. However, there is a delay in the distributed system, so that the sequence that the commit timestamp of T1 and the commit timestamp of T2 reach the standby database may be out of order, and therefore, the sequence of the two events of T1.Commit and T2.Commit is still uncertain.

The Apply log of the standby database inevitably ensures that the transaction commit sequence of T1 and T2 is kept unchanged, so that when S is created, T1.Prepare has been necessarily completed, and then there are two cases in the timing of T1.Commit:

if T1.Commit is earlier than T2.Commit, T1 is directly visible to S; and

if T1.Commit is later than T2.Commit, S is blocked and waits for T1.Commit to reach the standby database, and T1 being visible to S is then determined according to the timestamp.

Specifically, when the commit of T1 is earlier than the commit of T2, and T2 is the last write transaction, T1 is visible to S. When the commit of T1 is later than the commit of T2, but the commit timestamp of T1 is acquired before the commit timestamp of T2 is acquired, and T2.commit_seq is the maximum commit timestamp for the write transaction of the standby databases, while the commit of T1 is later than the commit of T2, then, S is blocked and waits for T1.Commit to reach the standby database, and T1 being visible to S is determined according to the maximum commit timestamp for the write transaction of the standby databases, to ensure the integrity of the read data of the standby database.

In the data reading method provided in the present disclosure, a current max_commit_seq is maintained on a standby database node. If a snapshot timestamp of a read transaction S meets snapshot_seq<max_commit_seq, it can be considered that the reading is “safe”, and the write transaction in the standby database is visible to the read transaction S. If this premise is not met, a block and waiting may be performed for a short duration of time (for example, 1 ms) and then a retrying is performed. When the maximum commit timestamp for the write transaction of the standby databases is greater than the snapshot timestamp of the read transaction S, the write transaction in the standby database is determined to be visible to the read transaction S, and the request of the read transaction to read data can be quickly and safely satisfied by blocking and waiting.

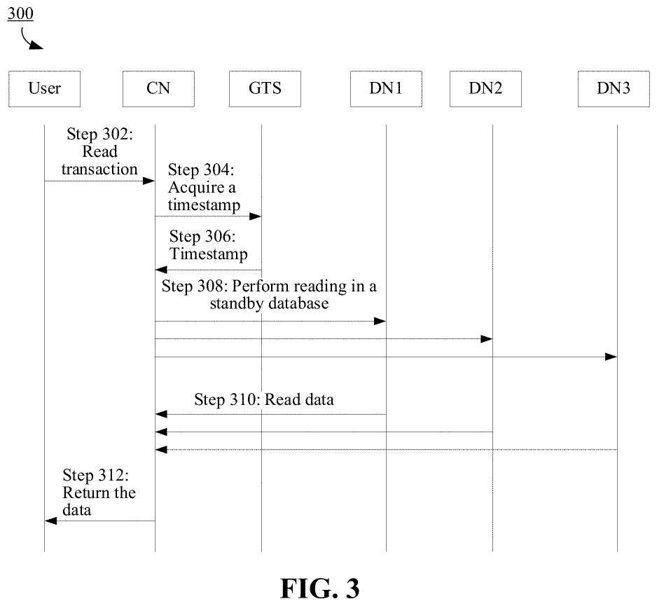

The data reading method is further described below by using the application of the data reading method provided in the present disclosure in a distributed database as an example with reference to FIG. 3. FIG. 3 is a flowchart of an example process of a first data reading method 300, according to some embodiments of the present disclosure. The first data reading method 300 specifically includes the steps 302 to 312.

During specific implementation, the data reading method 300 provided in this example includes a user, a CN, a GTS, and distributed standby databases DN1\DN2\DN3.

At step 302, the user sends a data reading transaction request to the CN.

At step 304, after receiving the data reading transaction request, the CN requests the GTS to generate a snapshot timestamp for a data reading transaction and acquires a maximum commit timestamp for a write transaction of the distributed standby databases DN1\DN2\DN3.

At step 306, after generating the snapshot timestamp for the data reading transaction and acquiring the maximum commit timestamp for the write transaction of the distributed standby databases DN1\DN2\DN3, the GTS returns the snapshot timestamp and the maximum commit timestamp to the CN.

At step 308, when the snapshot timestamp is determined to be smaller than the maximum commit timestamp, the CN sends the data reading transaction request carrying the snapshot timestamp to the corresponding distributed standby databases DN1\DN2\DN3 respectively.

At step 310, the distributed standby databases DN1\DN2\DN3 read data based on the data reading transaction request, and return the read data to the CN.

At step 312, the CN returns received data to the user.

In the data reading method provided in the present disclosure, acquisition for a timestamp is performed once, and consistency between read data of distributed standby databases and data of the corresponding primary databases can be ensured based on the timestamp, which greatly improves the user experience for data reading and querying in the distributed standby databases.

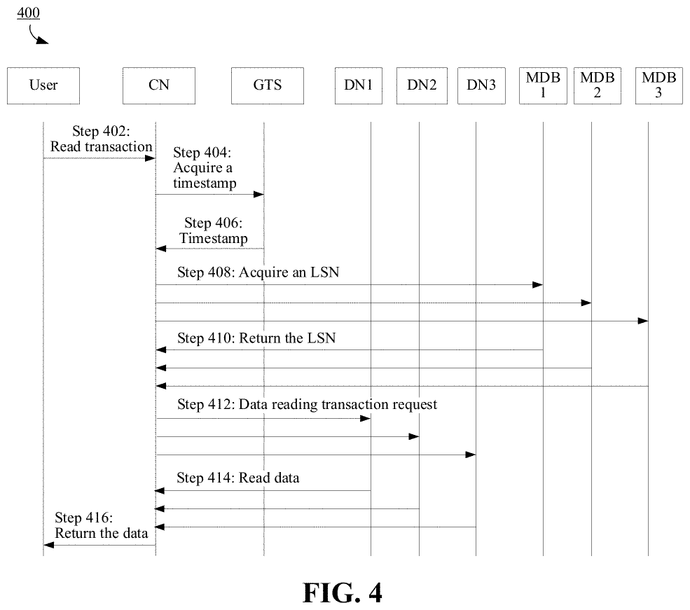

The data reading method is further described below by using the application of the data reading method provided in the present disclosure in a distributed database as an example with reference to FIG. 4. FIG. 4 is a flowchart of an example process of a second data reading method 400, according to some embodiments of the present disclosure. The second data reading method 400 includes the steps 402 to 416.

During specific implementation, the data reading method 400 provided in the present disclosure includes a user, a CN, a GTS, distributed standby databases DN1\DN2\DN3, and distributed primary databases MDB1\MDB2\MDB3.

At step 402, the user sends a data reading transaction request to the CN.

At step 404, after receiving the data reading transaction request, the CN requests the GTS to generate a snapshot timestamp for a data reading transaction and acquires a maximum commit timestamp for a write transaction of the distributed standby databases DN1\DN2\DN3.

At step 406, after generating the snapshot timestamp for the data reading transaction and acquiring the maximum commit timestamp for the write transaction of the distributed standby databases DN1\DN2\DN3, the GTS returns the snapshot timestamp and the maximum commit timestamp to the CN.

At step 408, when the snapshot timestamp is determined to be greater than the maximum commit timestamp for the write transaction of the distributed standby databases DN1\DN2\DN3, the CN reacquires a maximum commit timestamp for the write transaction of the distributed standby databases after waiting for a preset duration. When the snapshot timestamp is still greater than the maximum commit timestamp for the write transaction of the distributed standby databases DN1\DN2\DN3, the CN sends a request for acquiring an LSN to the distributed primary databases MDB1\MDB2\MDB3 respectively.

At step 410, after receiving the request for acquiring an LSN, the distributed primary databases MDB1\MDB2\MDB3 respectively return the corresponding LSN to the CN.

At step 412, the CN sends the data reading transaction request carrying the corresponding LSN to the corresponding distributed standby databases DN1\DN2\DN3 respectively.

At step 414, after receiving the data reading transaction request carrying the LSN, and waiting for an LSN of the local log Apply reaches the LSN carried in the currently received data reading transaction request, the distributed standby databases DN1\DN2\DN3 perform data reading based on the data reading transaction request, and return the read data to the CN.

At step 416, the CN returns received data to the user.

In the data reading method provided in the present disclosure, a current maximum commit timestamp (max_commit_seq) is maintained on a standby database DN node. If the snapshot timestamp meets snapshot_seq>max_commit_seq on the standby database DN node, it can be considered that the reading is “safe”, and data reading can be performed directly. If this premise is not met, retrying can be performed after a short period of time (for example, 1 ms) is waited for, that is, and a maximum commit timestamp (max_commit_seq) for the current write transaction maintained by the standby database DN node is reacquired. If the premise is still not met, a current LSN is acquired from the primary database first, and after the LSN of the standby database is waited for to reach the current LSN, data reading is performed in the standby database to ensure that the read standby database data is consistent with that from the primary database. When reading standby database data in the three manners, the data read from the standby database and the data read from the primary database based on the same data reading transaction are ensured to be kept consistent, which improves the user experience for data reading, and reading of the standby database can be generally completed within one round-trip (RT), thereby improving the data querying performance.

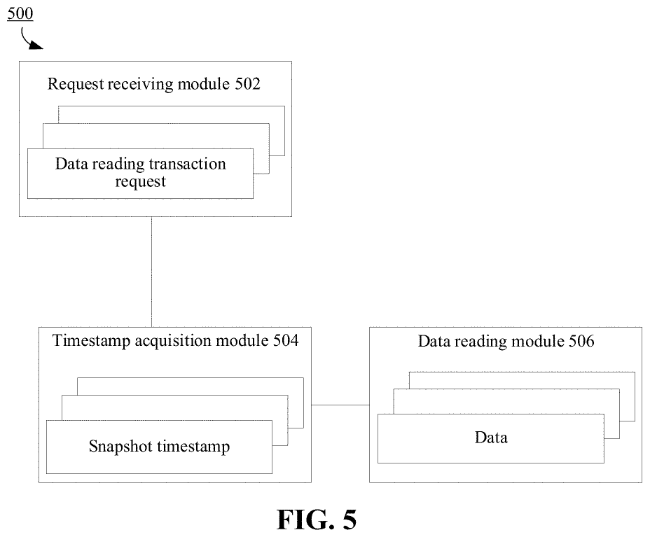

Corresponding to the foregoing method embodiments, the present disclosure further provides embodiments of a data reading apparatus. FIG. 5 is a schematic structural diagram of an example data reading apparatus, according to some embodiments of the present disclosure. As shown in FIG. 5, the apparatus 500 includes a request receiving module 502, a timestamp acquisition module 504, and a data reading module 506.

The request receiving module 502 is configured to receive a data reading transaction request.

The timestamp acquisition module 504 is configured to acquire a snapshot timestamp based on the data reading transaction request.

The data reading module 506 is configured to send, when the snapshot timestamp is less than a maximum commit timestamp for a write transaction of a first database, the data reading transaction request carrying the snapshot timestamp to the first database for data reading.

In some embodiments, the data reading module 506 is further configured to send, when the snapshot timestamp is less than a maximum commit timestamp for a write transaction of a second database to the first database, the data reading transaction request carrying the snapshot timestamp to the first database for data reading, where the first database is a backup database of the second database.

In some embodiments, the apparatus 500 further includes a retry module. The retry module is configured to reacquire, when the snapshot timestamp is greater than the maximum commit timestamp for the write transaction of the first database, a maximum commit timestamp for the write transaction of the first database after waiting for a preset duration.

In some embodiments, the apparatus 500 further includes a first sequence number acquisition module, a second sequence number acquisition module, and a sequence number matching module. The first sequence number acquisition module is configured to acquire an LSN of a second database when the snapshot timestamp is less than the maximum commit timestamp for the write transaction of the first database.

The second sequence number acquisition module is configured to send the data reading transaction request carrying the LSN of the second database to the first database, and acquire an LSN of the first database.

The sequence number matching module is configured to read data in the first database based on the data reading transaction request and the LSN of the first database when the LSN of the first database is determined to match the LSN of the second database.

In some embodiments, the first sequence number acquisition module is further configured to acquire an LSN of the last complete database backup of the second database; and the second sequence number acquisition module is correspondingly further configured to acquire an LSN of the last complete database backup of the first database.

In some embodiments, the apparatus 500 further includes a database determining module. The database determining module is configured to determine at least one corresponding second database based on the data reading transaction request.

In some embodiments, the first sequence number acquisition module is further configured to acquire an LSN of each second database; and the second sequence number acquisition module is correspondingly further configured to send the data reading transaction request carrying the LSN of the second database to the first database corresponding to each second database.

In some embodiments, the data reading method is applicable to a distributed database.

By using the data reading apparatus provided in the embodiments of the present disclosure, acquisition for a timestamp is performed once, and consistency between data of distributed standby databases and data of the corresponding primary database read under the same data reading transaction request can be ensured based on the timestamp, which greatly improves the user experience for data reading and querying in the distributed standby databases.

The foregoing describes an exemplary solution of the data reading apparatus. It should be noted that, the technical solution of the data reading apparatus and the technical solution of the data reading method belong to the same conception, and for detailed content of the technical solution of the data reading apparatus that is not described in detail, reference may be made to the description of the technical solution of the foregoing data reading method.

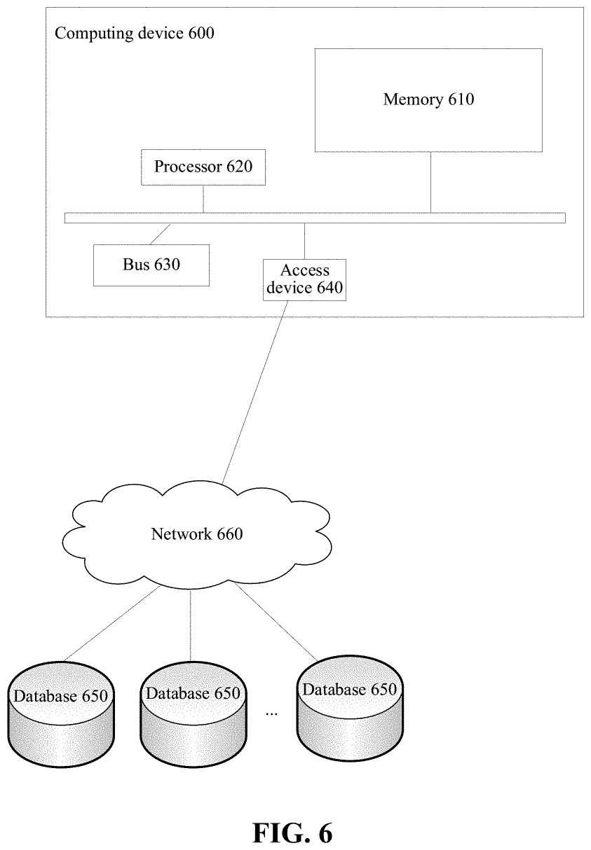

FIG. 6 is a structural block diagram of an example computing device 600, according to some embodiments of the present disclosure. The computing device 600 includes, but are not limited to, a memory 610 and one or more processors 620. The processor 620 and the memory 610 are connected through a bus 630, and a database 650 is configured to store data.

The computing device 600 further includes an access device 640, and the access device 640 enables the computing device 600 to communicate through one or more networks 660. Examples of these networks include a public switched telephone network (PSTN), a local area network (LAN), a wide area network (WAN), a personal area network (PAN), or a combination of communication networks such as the internet. The access device 640 may include one or more of wired or wireless network interfaces (for example, a network interface card (NIC)) of any types, such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, a near field communication (NFC) interface, and the like.

In some embodiments, the foregoing components and other components not shown in FIG. 6 of the computing device 600 may be connected, for example, through the bus. It should be understood that the structural block diagram of the computing device shown in FIG. 6 is merely exemplary, and is not intended to limit the scope of the present disclosure. A person skilled in the art may add or replace other components according to a requirement.

The computing device 600 may be a stationary or mobile computing device of any type, including a mobile computer, a mobile computing device (for example, a tablet computer, a person digital assistant, a laptop computer, a notebook, or a netbook), a mobile phone (for example, a smartphone), a wearable computing device (for example, a smartwatch or smart glasses), a mobile device of another type, or a stationary computing device such as a desktop computer or a personal computer (PC). The computing device 600 may alternatively be a mobile or stationary server.

The processor 620 is configured to execute the computer-executable instructions, and the processor, when executing the computer-executable instructions, implements the data reading method.

The foregoing describes an exemplary solution of the computing device. It should be noted that, the technical solution of the computing device and the technical solution of the data reading method belong to the same conception, and for detailed content of the technical solution of the computing device that is not described in detail, reference may be made to the description of the technical solution of the foregoing data reading method.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The modules, such as transaction coordination module, timestamp distribution module, request receiving module, acquisition module, data reading module, retry module, first sequence number acquisition module, second sequence number acquisition module, and a sequence number matching module, database determining module, described in this disclosure can be implemented by circuitry, hardware, or software, or a combination of hardware and software. It is appreciated that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A data reading method, comprising:
receiving a data reading transaction request;
acquiring a snapshot timestamp based on the data reading transaction request; and
sending, when the snapshot timestamp is less than a maximum commit timestamp for a write transaction of a first database, the data reading transaction request carrying the snapshot timestamp to the first database for data reading.

2. The data reading method according to claim 1, wherein that the snapshot timestamp is less than the maximum commit timestamp for the write transaction of the first database comprises:
the snapshot timestamp being less than a maximum commit timestamp for a write transaction of a second database to the first database, wherein the first database is a backup database of the second database.

3. The data reading method according to claim 1, wherein after the acquiring the snapshot timestamp based on the data reading transaction request, the method further comprises:
reacquiring, when the snapshot timestamp is greater than the maximum commit timestamp for the write transaction of the first database, the maximum commit timestamp for the write transaction of the first database after waiting for a preset duration.

4. The data reading method according to claim 3, wherein after the reacquiring the maximum commit timestamp for the write transaction of the first database after waiting for the preset duration, the method further comprises:
acquiring a log sequence number (LSN) of a second database when the snapshot timestamp is less than the maximum commit timestamp for the write transaction of the first database;
sending the data reading transaction request carrying the LSN of the second database to the first database, and acquiring an LSN of the first database; and
reading data in the first database based on the data reading transaction request and the LSN of the first database when the LSN of the first database is determined to match the LSN of the second database.

5. The data reading method according to claim 4, wherein the acquiring the LSN of the second database comprises:
acquiring an LSN of a last complete database backup of the second database; and
the acquiring an LSN of the first database comprises:
acquiring an LSN of a last complete database backup of the first database.

6. The data reading method according to claim 4, wherein after the receiving the data reading transaction request, the method further comprises:
determining at least one corresponding second database based on the data reading transaction request.

7. The data reading method according to claim 6, wherein the acquiring the LSN of the second database comprises:
acquiring an LSN of each second database; and
the sending the data reading transaction request carrying the LSN of the second database to the first database comprises:
sending the data reading transaction request carrying the LSN of the second database to a first database corresponding to each second database.

8. The data reading method according to claim 1, wherein the data reading method is applicable to a distributed database.

9. An apparatus for performing data reading, comprising:
a memory configured to store instructions; and
one or more processor configured to execute the instructions to cause the apparatus to perform:
receiving a data reading transaction request;
acquiring a snapshot timestamp based on the data reading transaction request; and
sending, when the snapshot timestamp is less than a maximum commit timestamp for a write transaction of a first database, the data reading transaction request carrying the snapshot timestamp to the first database for data reading.

10. The apparatus according to claim 9, wherein that the snapshot timestamp is less than the maximum commit timestamp for the write transaction of the first database comprises:
the snapshot timestamp being less than a maximum commit timestamp for a write transaction of a second database to the first database, wherein the first database is a backup database of the second database.

11. The apparatus according to claim 9, wherein after the acquiring the snapshot timestamp based on the data reading transaction request, the one or more processor are further configured to execute the instructions to cause the apparatus to perform:
reacquiring, when the snapshot timestamp is greater than the maximum commit timestamp for the write transaction of the first database, the maximum commit timestamp for the write transaction of the first database after waiting for a preset duration.

12. The apparatus according to claim 11, wherein after the reacquiring the maximum commit timestamp for the write transaction of the first database after waiting for the preset duration, the one or more processor are further configured to execute the instructions to cause the apparatus to perform:
acquiring a log sequence number (LSN) of a second database when the snapshot timestamp is less than the maximum commit timestamp for the write transaction of the first database;
sending the data reading transaction request carrying the LSN of the second database to the first database, and acquiring an LSN of the first database; and
reading data in the first database based on the data reading transaction request and the LSN of the first database when the LSN of the first database is determined to match the LSN of the second database.

13. The apparatus according to claim 12, wherein in acquiring the LSN of the second database, the one or more processor are further configured to execute the instructions to cause the apparatus to perform:
acquiring an LSN of a last complete database backup of the second database; and
in acquiring an LSN of the first database, the one or more processor are further configured to execute the instructions to cause the apparatus to perform:
acquiring an LSN of a last complete database backup of the first database.

14. The apparatus according to claim 12, wherein after the receiving the data reading transaction request, the one or more processor are further configured to execute the instructions to cause the apparatus to perform:
determining at least one corresponding second database based on the data reading transaction request.

15. A non-transitory computer readable medium that stores a set of instructions that is executable by one or more processors of an apparatus to cause the apparatus to initiate a method for performing data reading, the method comprising:
receiving a data reading transaction request;
acquiring a snapshot timestamp based on the data reading transaction request; and
sending, when the snapshot timestamp is less than a maximum commit timestamp for a write transaction of a first database, the data reading transaction request carrying the snapshot timestamp to the first database for data reading.

16. The non-transitory computer readable medium according to claim 15, wherein that the snapshot timestamp is less than the maximum commit timestamp for the write transaction of the first database comprises:
the snapshot timestamp being less than a maximum commit timestamp for a write transaction of a second database to the first database, wherein the first database is a backup database of the second database.

17. The non-transitory computer readable medium according to claim 15, wherein after the acquiring the snapshot timestamp based on the data reading transaction request, the method further comprises:
reacquiring, when the snapshot timestamp is greater than the maximum commit timestamp for the write transaction of the first database, the maximum commit timestamp for the write transaction of the first database after waiting for a preset duration.

18. The non-transitory computer readable medium according to claim 17, after the reacquiring the maximum commit timestamp for the write transaction of the first database after waiting for the preset duration, the method further comprises:
acquiring a log sequence number (LSN) of a second database when the snapshot timestamp is less than the maximum commit timestamp for the write transaction of the first database;
sending the data reading transaction request carrying the LSN of the second database to the first database, and acquiring an LSN of the first database; and
reading data in the first database based on the data reading transaction request and the LSN of the first database when the LSN of the first database is determined to match the LSN of the second database.

19. The non-transitory computer readable medium according to claim 18, wherein the acquiring the LSN of the second database comprises:
acquiring an LSN of a last complete database backup of the second database; and
the acquiring an LSN of the first database comprises:
acquiring an LSN of a last complete database backup of the first database.

20. The non-transitory computer readable medium according to claim 18, wherein after the receiving the data reading transaction request, the method further comprises:
determining at least one corresponding second database based on the data reading transaction request.
